(19) United States
(12) Patent Application Publication
(10) Pub. No.: US 2025/0275643 A1
(43) Pub. Date: Sep. 4, 2025

(54) COFFEE BREWING APPARATUS AND METHOD

(71) Applicant: Conair LLC, Stamford, CT (US)

(72) Inventors: Wing Po CHAN, Hong Kong (CN); Yik On YIU, Hong Kong (CN)

(73) Assignee: Conair LLC, Stamford, CT (US)

(21) Appl. No.: 18/591,155

(22) Filed: Feb. 29, 2024

(51) Int. Cl. A47J 31/42; A47J 31/06

(52) U.S. Cl. CPC A47J 31/42; A47J 31/0689

(57) ABSTRACT

A coffee brewing apparatus includes a housing, a grinding system associated with the housing, the grinding system having a grinding mechanism for grinding coffee beans to transform the coffee beans into coffee grounds, and a brewing system associated with the housing, the brewing system including a brewing chamber for receiving a cartridge, and a flow pathway for delivering heated water to the cartridge.

### FIELD OF THE INVENTION

The present invention relates generally to beverage making devices and, more particularly, to a coffee brewing apparatus and method.

### BACKGROUND OF THE INVENTION

Various types of beverage brewers, such as single-serve beverage brewers, have been developed and are popular for home brewing of coffee and other beverages. In a typical single-serve beverage brewer, a disposable beverage filter cartridge containing a dry beverage medium (such as tea or coffee) is disposed within a filter cartridge holder or brewing holster of a beverage or coffee machine. To brew the beverage, the filter cartridge is pierced by inlet and outlet probes to accommodate a through-flow of metered hot water. The hot water infuses the dry beverage medium contained in the cartridge to thereby produce a single serving of the beverage. After the beverage is brewed, the cartridge is removed from the cartridge holder and it is discarded.

Existing coffee machines and single-serve cartridges, including those of the reusable variety, are typically only capable of brewing a single type of coffee such as, for example, espresso or drip coffee, but not both. Moreover, most existing coffee machines are only configured to receive a specific type of cartridge or pod, and cannot accommodate cartridges/pods from different manufacturers.

In view of the above, there is a need for a coffee brewing apparatus that is configured to accommodate a variety of single use and reusable beverage cartridges/pods of different style and/or configuration, and which has both grinding and brewing functions.

### SUMMARY OF THE INVENTION

It is an object of the present invention to provide a coffee brewing apparatus.

It is another object of the present invention to provide a coffee brewing apparatus having both grinding and brewing functions.

It is another object of the present invention to provide a coffee brewing apparatus which can accommodate a variety of single use and reusable beverage cartridges/pods of different style and/or configuration.

It is another object of the present invention to provide a coffee brewing apparatus which is configured for both high-pressure and low-pressure brewing operations.

It is another object of the present invention to provide a coffee brewing apparatus which is configured to produce a variety of coffee beverages of different types.

These and other objects are achieved by the present invention.

According to an embodiment of the present invention, a coffee brewing apparatus includes a housing, a grinding system associated with the housing, the grinding system having a grinding mechanism for grinding coffee beans to transform the coffee beans into coffee grounds, and a brewing system associated with the housing, the brewing system including a brewing chamber for receiving a cartridge, and a flow pathway for delivering heated water to the cartridge.

According to yet another embodiment of the present invention, a method for producing coffee includes the steps of positioning a cartridge beneath a grinding mechanism of a coffee brewing apparatus, actuating the grinding mechanism to transform coffee beans into coffee grounds, collecting the coffee grounds in the cartridge, moving the cartridge with coffee grounds from a position beneath the grinding mechanism to a brewing chamber within a brew head located adjacent to the grinding mechanism, and initiating a brewing operation to cause heated water to pass through the coffee grounds within the cartridge.

According to yet another embodiment of the present invention, a coffee brewing apparatus includes a housing, a grinding system located on a front the housing, the grinding system having a grinding mechanism for grinding coffee beans to transform the coffee beans into coffee grounds, a cartridge holder located beneath the grinding mechanism for holding the cartridge beneath the grinding mechanism, for collection of the coffee grounds discharged by the grinding mechanism in the cartridge, and a brew head located on the front of the housing adjacent to the grinding system, the brew head including a brewing chamber for receiving the cartridge containing the coffee grounds, the brew head being movable between an open position allowing access to the brewing chamber for insertion and/or removal of the cartridge, and a closed position.

### BRIEF DESCRIPTION OF THE DRAWINGS

The present invention will be better understood from reading the following description of non-limiting embodiments, with reference to the attached drawings, wherein below:

FIG. 1 is a perspective, front view of a coffee brewing apparatus according to an embodiment of the present invention.

FIG. 2 is a perspective, bottom view of coffee brewing apparatus of FIG. 1.

FIG. 3 is a front elevational view of the coffee brewing apparatus of FIG. 1.

FIG. 4 is a left side elevational view of the coffee brewing apparatus of FIG. 1.

FIG. 5 is a right side elevational view of the coffee brewing apparatus of FIG. 1.

FIG. 6 is a top plan view of the coffee brewing apparatus of FIG. 1.

FIG. 7 is a side, cross-sectional view of the coffee brewing apparatus of FIG. 1.

FIG. 8 is a schematic illustration of a brewing system of the coffee brewing apparatus of FIG. 1.

FIG. 9 is a cross-sectional view of a portion of the coffee brewing apparatus, showing a brewing operation.

FIG. 10 is a front elevational view of a grinding system of the coffee brewing apparatus of FIG. 1, according to an embodiment of the invention.

FIG. 11 is a cross-sectional view of the grinding system of the coffee brewing apparatus of FIG. 1.

FIG. 12 is a schematic illustration of the coffee brewing apparatus of FIG. 1, showing an alternative grinding system.

FIG. 13 is a schematic illustration of the coffee brewing apparatus of FIG. 1, showing an alternative grinding system.

FIG. 14 is a schematic illustration of the coffee brewing apparatus of FIG. 1, showing an alternative grinding system.

FIG. 15 is a perspective, top view of a reusable coffee and beverage pod for use with the coffee brewing apparatus of FIG. 1.

FIG. 16 is a side, cross-sectional view of the reusable coffee and beverage pod of FIG. 15.

FIG. 17 is a cross-sectional view of a portion of the coffee brewing apparatus, illustrating use with a dual-pressure brewing pod.

FIG. 18 is a side-cross-sectional view of a portion of the coffee brewing apparatus, illustrating a locking mechanism thereof.

FIG. 19 is a top, cross-sectional view of a portion of the coffee brewing apparatus, illustrating the locking mechanism thereof.

FIG. 20 is a front elevational view of the coffee brewing apparatus of FIG. 1, showing a dual pressure brewing pod in a grinding position.

FIG. 21 is a front elevational view of the coffee brewing apparatus of FIG. 1, showing a dual pressure brewing pod in a brewing position.

FIG. 22 is a front elevational view of a portion of the coffee brewing apparatus, showing the grinding system in a fine grind position.

FIG. 23 is a side elevational view of the coffee brewing apparatus, illustrating a grinding operation.

FIG. 24 is a perspective view of the coffee brewing apparatus, illustrating the reusable coffee pod in the brewing position.

FIG. 25 is a perspective view of the coffee brewing apparatus, illustrating a brewing operation.

FIG. 26 is a perspective view of a K-cup pod holder for use with the coffee brewing apparatus of FIG. 1.

FIG. 27 is a perspective view of a Dolce Gusto pod holder for use with the coffee brewing apparatus of FIG. 1.

FIG. 28 is a perspective view of a Nespresso pod holder for use with the coffee brewing apparatus of FIG. 1.

FIG. 29 is a perspective view of a portion of the coffee brewing apparatus, illustrating use of different pod holders.

FIG. 30 is a perspective view of a brew head of the coffee brewing apparatus of FIG. 1.

FIG. 31 is a side, cross-sectional view of the brew head of the coffee brewing apparatus of FIG. 1.

FIG. 32 is another perspective view of the K-cup pod holder of FIG. 26.

FIG. 33 is a cross-sectional view of the K-cup pod holder of FIG. 26.

FIG. 34 is a cross-sectional view of a portion of the coffee brewing apparatus, showing use of the K-cup pod holder of FIG. 26.

FIG. 35 is another perspective view of the Dolce Gusto pod holder of FIG. 27.

FIG. 36 is a cross-sectional view of the Dolce Gusto pod holder of FIG. 27.

FIG. 37 is a cross-sectional view of a portion of the coffee brewing apparatus, showing use of the Dolce Gusto pod holder of FIG. 27.

FIG. 38 is another perspective view of the Nespresso pod holder of FIG. 28.

FIG. 39 is a perspective view of a portion of the coffee brewing apparatus, showing use of the Nespresso pod holder of FIG. 28.

FIG. 40 is a cross-sectional view of a portion of the coffee brewing apparatus, showing use of the Nespresso pod holder of FIG. 28.

FIG. 41 is another cross-sectional view of a portion of the coffee brewing apparatus, showing use of the Nespresso pod holder of FIG. 28.

### DETAILED DESCRIPTION OF THE PREFERRED EMBODIMENT

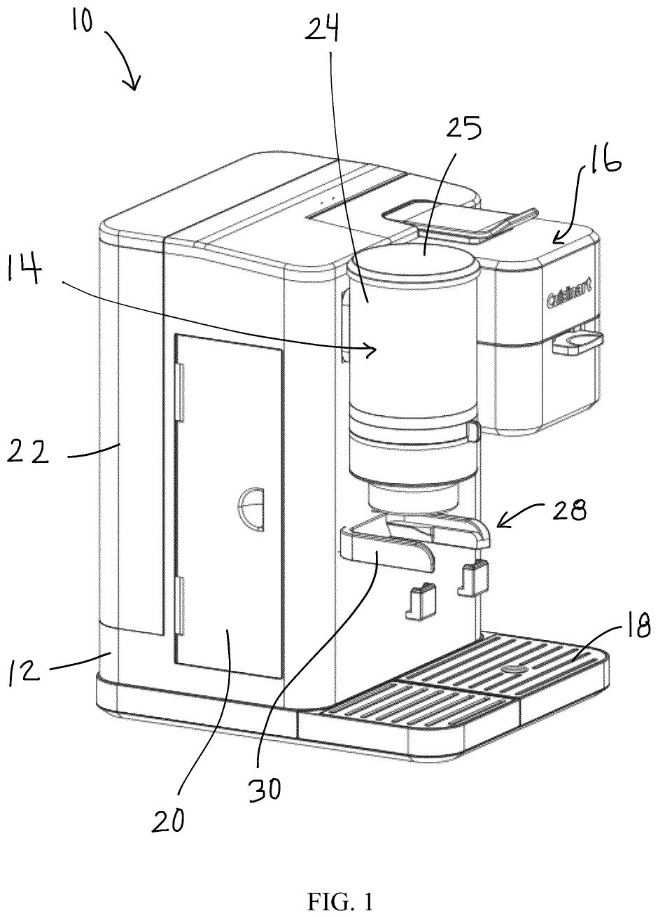

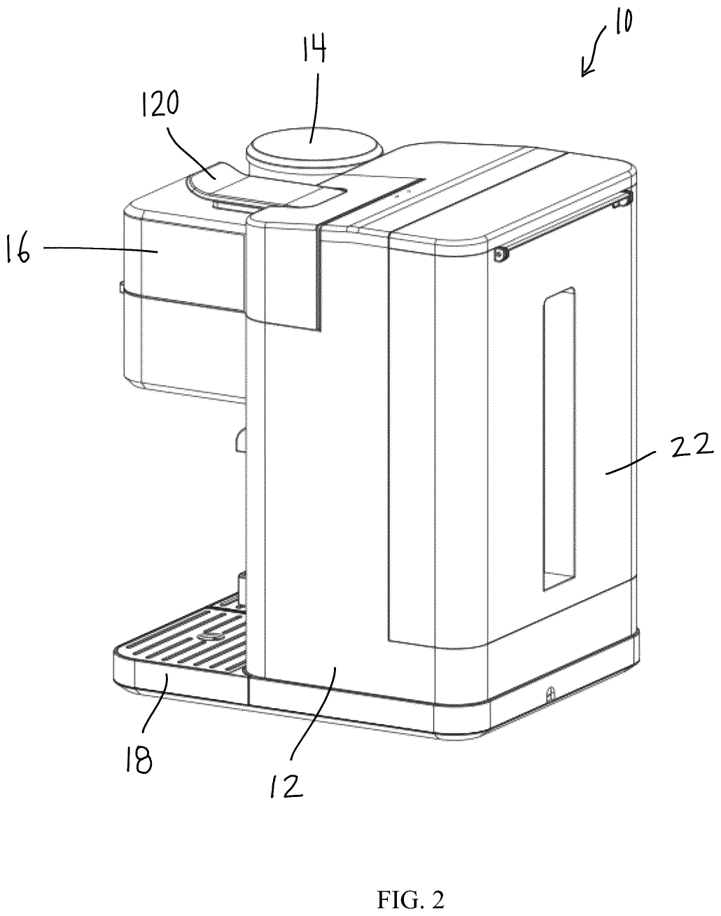

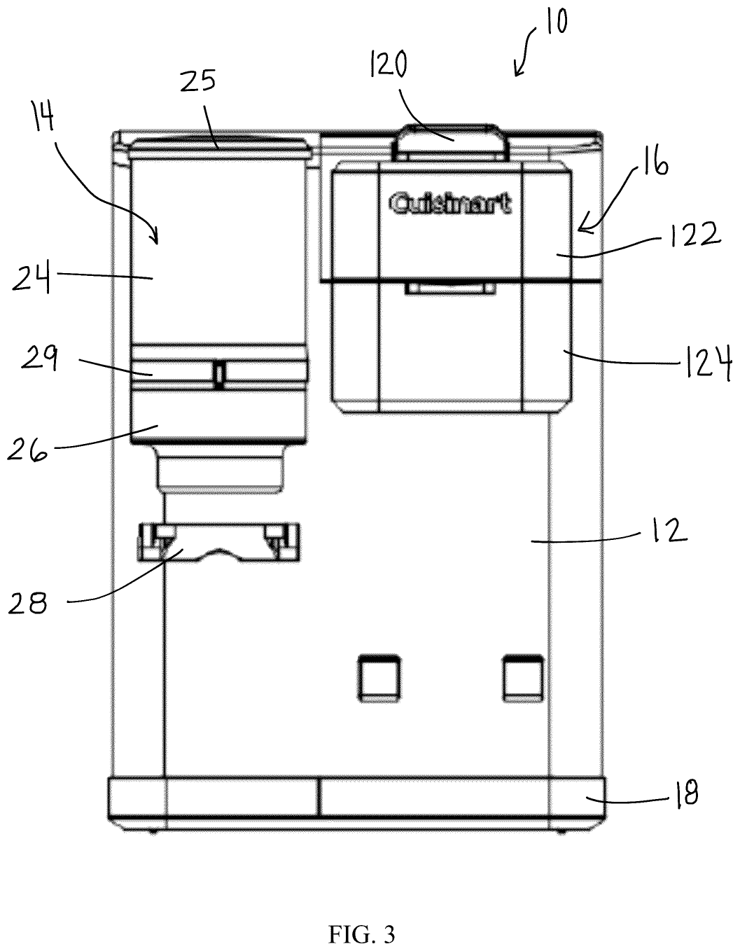

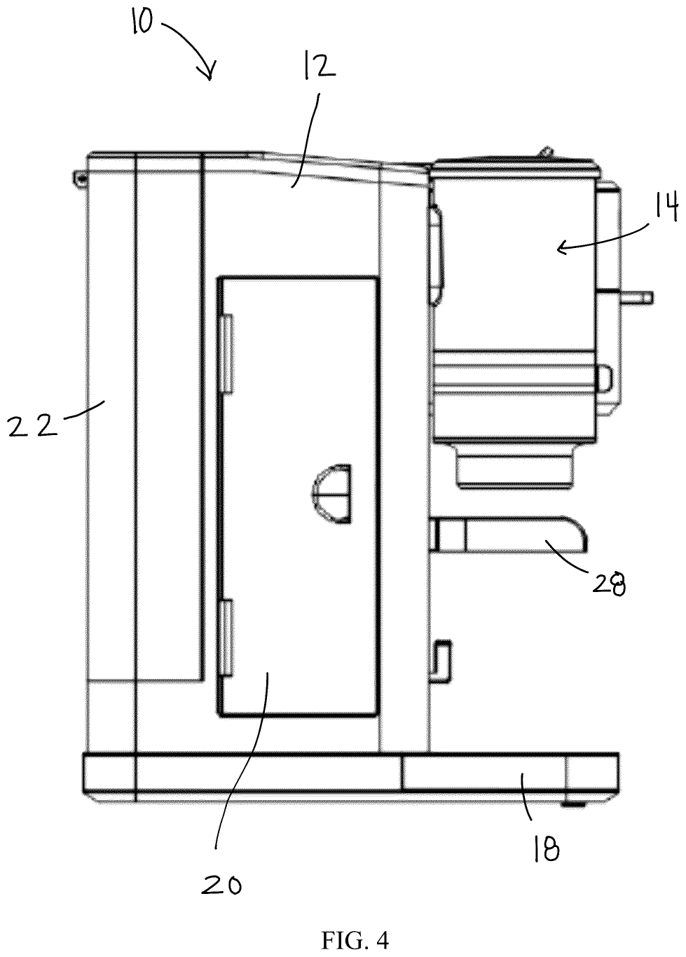

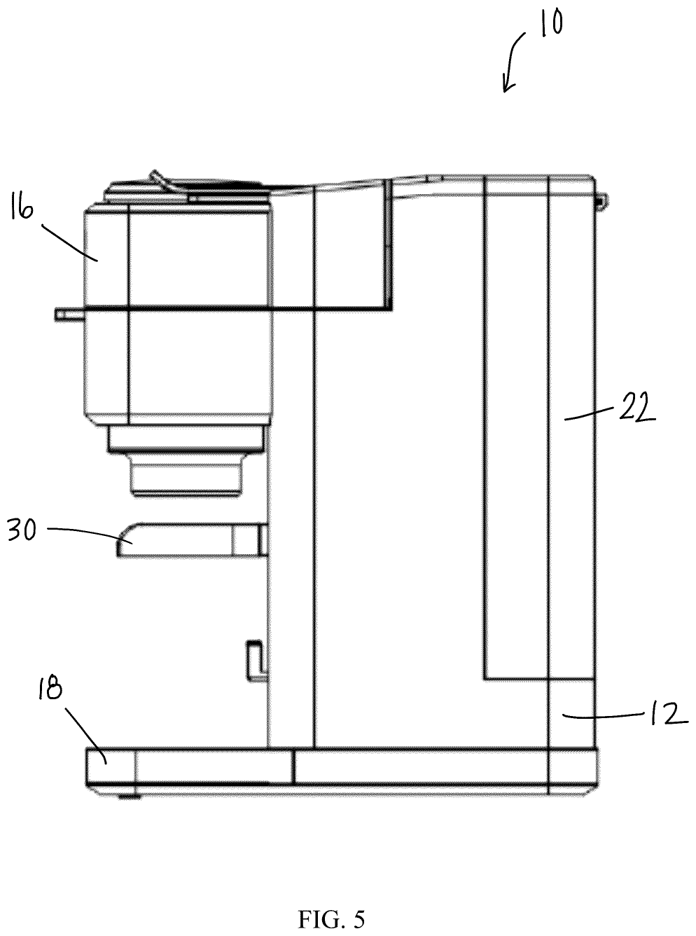

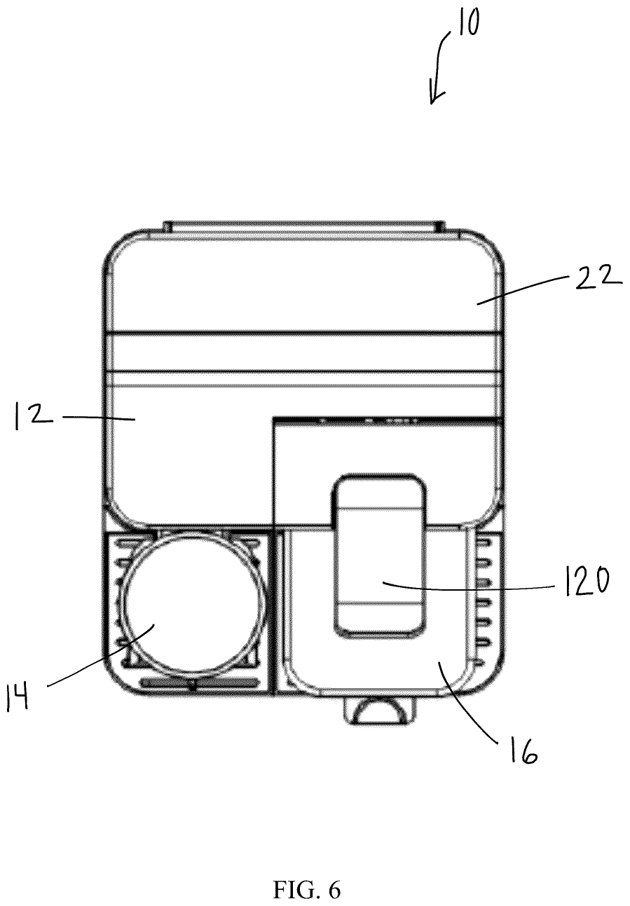

With reference to FIGS. 1-7, a coffee brewing apparatus 10 according to an embodiment of the present invention is shown. The coffee brewing apparatus includes a generally rectangular housing 12, a grinding system having a grinding head 14 supported by the housing 12, and a brew head 16 of a brewing system supported by the housing 12. As shown in FIGS. 1 and 3, for example, in an embodiment, the grinding head 14 and brew head 16 are arranged adjacent to one another on a front of the housing 12. A drip tray 18 having a slotted upper surface extends forwardly from the housing 12 at a lower portion of the housing 12, and is configured to receive a cup or mug thereon for receiving a brewed beverage from the brew head 16. The housing 12 includes an access door or panel 20 on one side thereof, permitting access to internal components of the apparatus 10, and includes a reservoir 22 for holding a volume of water for use in a brewing operation, as described in detail below.

As best shown in FIGS. 3, 8 and 9, the primary components of the grinding system/grinding head 14 are shown, and include a hopper 24 having a removable lid 25, a motor 27, and a grinding mechanism such as, for example, a burr grinder 26 mounted beneath the motor 27 and operatively connected to the motor 27 so as to be rotatably driven by the motor 27, and a cartridge holder 28 extending forwardly from the housing 12 beneath the burr grinder 26. In an embodiment, the cartridge holder 28 includes a pair of arms 30 that extend forwardly from the housing 12, which are configured to receive a reusable pod or cartridge (not shown).

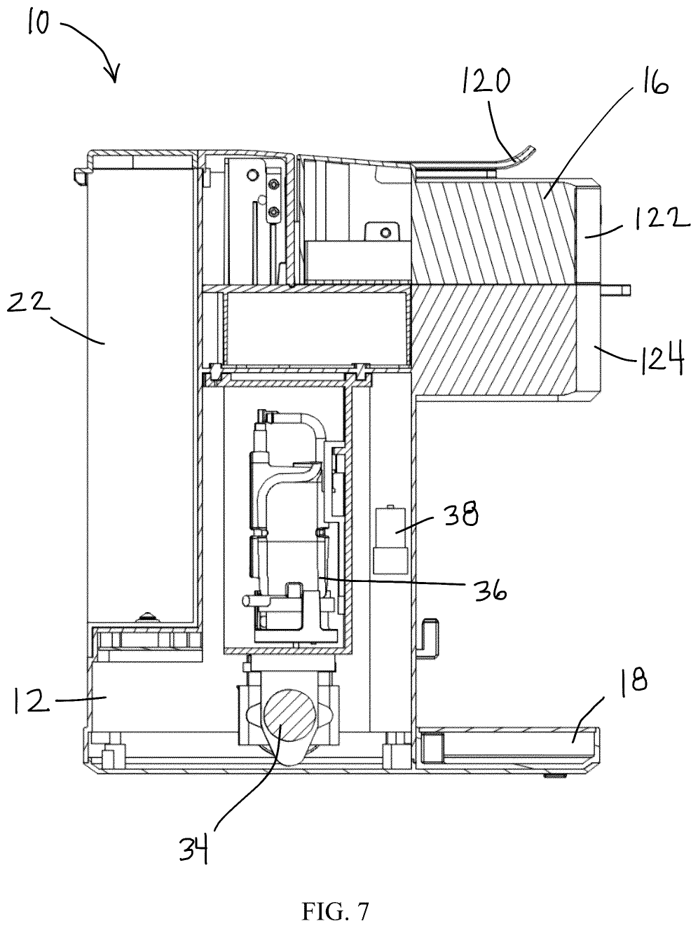

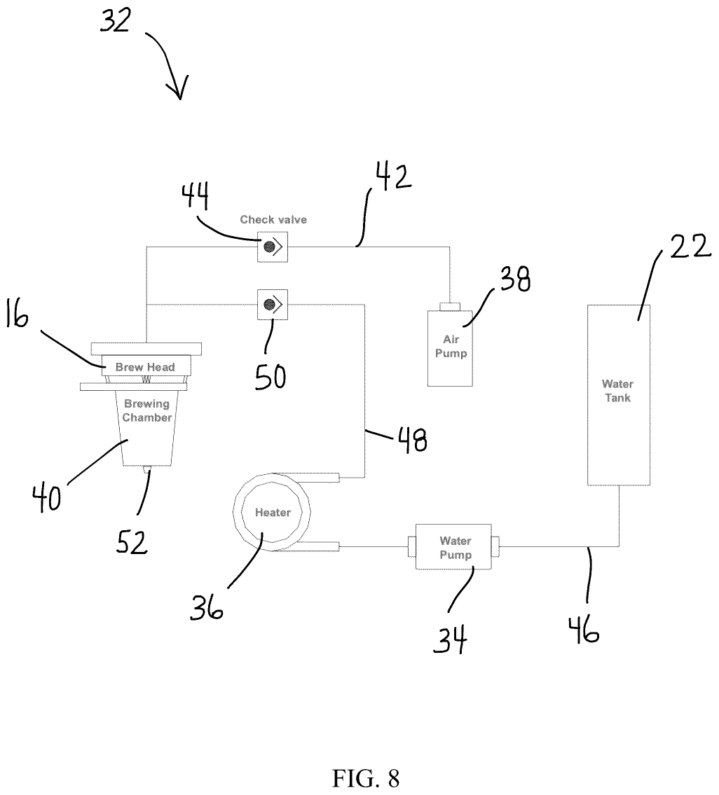

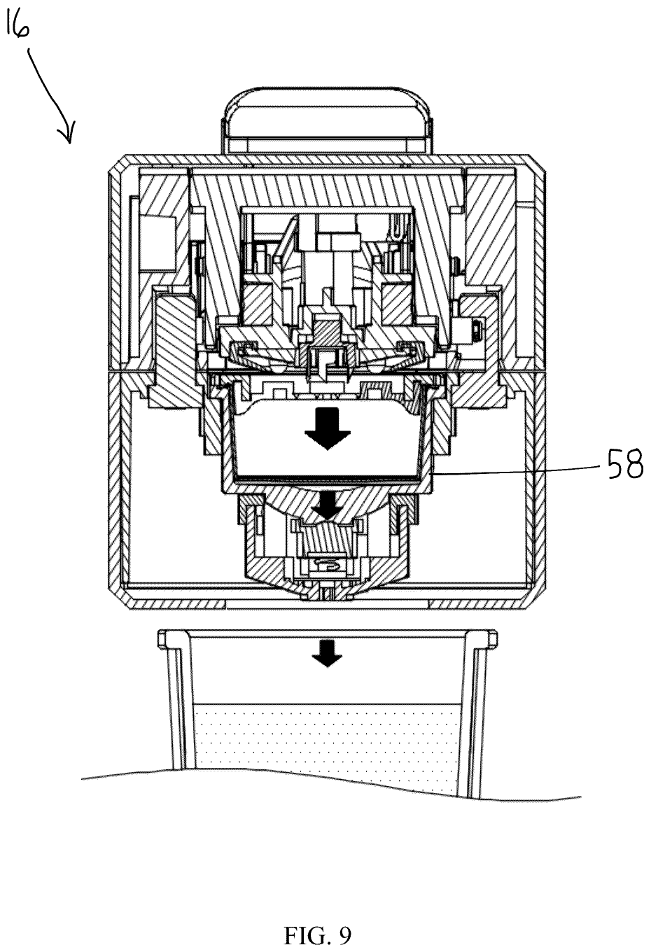

As best shown in FIG. 7, the primary components of the brewing system 32 of the coffee brewing apparatus are shown, and include the water reservoir 22 for containing a volume of water, a water pump 34, a heater 36 and an air pump 38. As shown in FIG. 8, the brewing system 32 further includes the brew head 16 and brewing chamber 40 (which receives a reusable or disposable pod or cartridge containing one or more dry beverage ingredients). In particular, the brew head 16 is moveable between an open position where the brewing chamber 40 is accessible to remove or insert a beverage pod or cartridge, and a closed position, as discussed in detail hereinafter).As also shown therein, the air pump is fluidly connected to the brew head 16 via a flow line 42 having a check valve 44. The water reservoir 22 is likewise fluidly connected to the brew head 16 via flow line 46 that extends between the reservoir 22 and heater 36, and flow line 48 that extends from the heater 36 to the brew head. Check valve 50 is positioned along flow line 48 for controlling a flow of heated water therethrough. In operation, water is pumped from the reservoir 22 by pump 34 to the heater 36 where it is heated to a target temperature. The heater 36 may be any type of heater known in the art, such as an in-line heater. Hot water then flows through flow line 48, across check valve 50, and to the brew head 16. The water pump 34 pushes the hot water through coffee grounds or other beverage ingredients within the brewing chamber 40, producing brewed coffee which exits through an opening 52 in the bottom of the brewing chamber 40, as illustrated in FIG. 9. In an embodiment, the air pump 38 is then actuated to pump air into the brewing chamber 40 to dry out the brewing chamber 40.

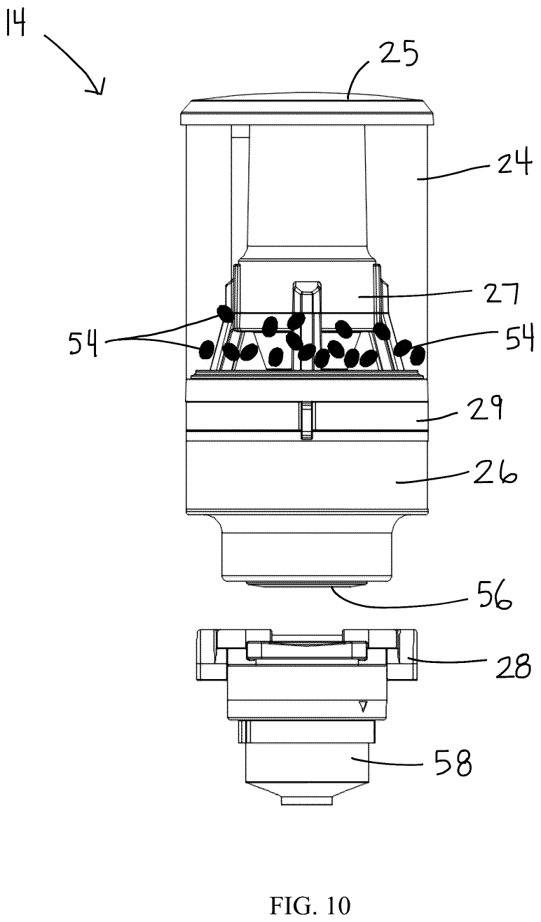

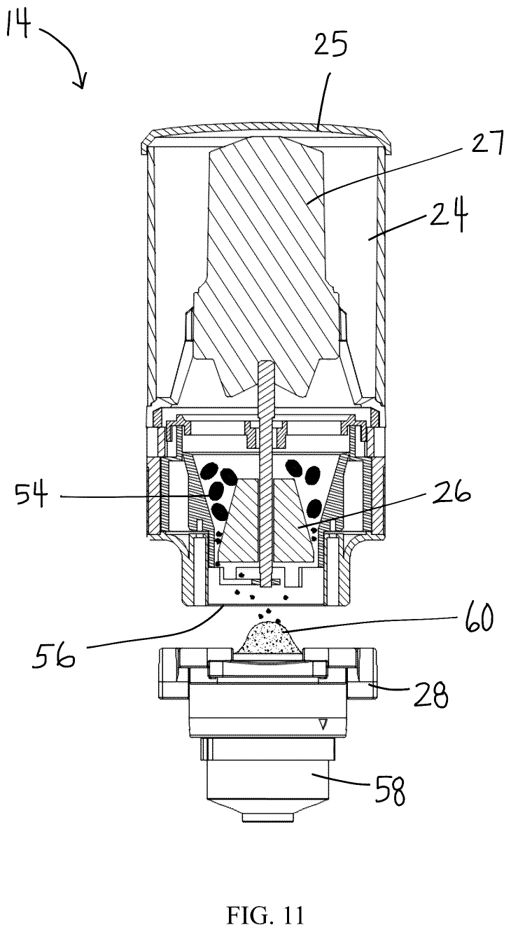

Turning now to FIGS. 10 and 11, the configuration and operation of the grinding system/grinding head 14 is shown. As shown therein, and as disclosed above, the grinding head 14 includes a hopper 24 for receiving for example, whole coffee beans 54, a motor 27, and a grinding mechanism in the form of a burr grinder 26 rotatably driven by the motor 27. In operation, whole coffee beans 54 or other ingredients to be processed are loaded into the hopper 24. The beans 54 follow the slide into the burr grinder 26. The motor 27 drives the burr grinder 26 to grind the coffee beans 54 into coffee grounds 60 which exit the grinding head 14 via an outlet 56 on an underside of the burr grinder 26. The coffee grounds are then collected by a reusable beverage pod or cartridge 58 received by the cartridge holder 28 beneath the burr grinder 26. In an embodiment, the burr grinder 26 is connected to the grinder motor 27 by a clutch structure, which allows the assembly to be removed and/or disassembled for cleaning. In an embodiment, the grinding head 14 also includes an adjustment ring 29 which allows a user to adjust the coarseness or fineness of the coffee grounds (by adjusting the spacing between the burrs of the burr grinder 26).

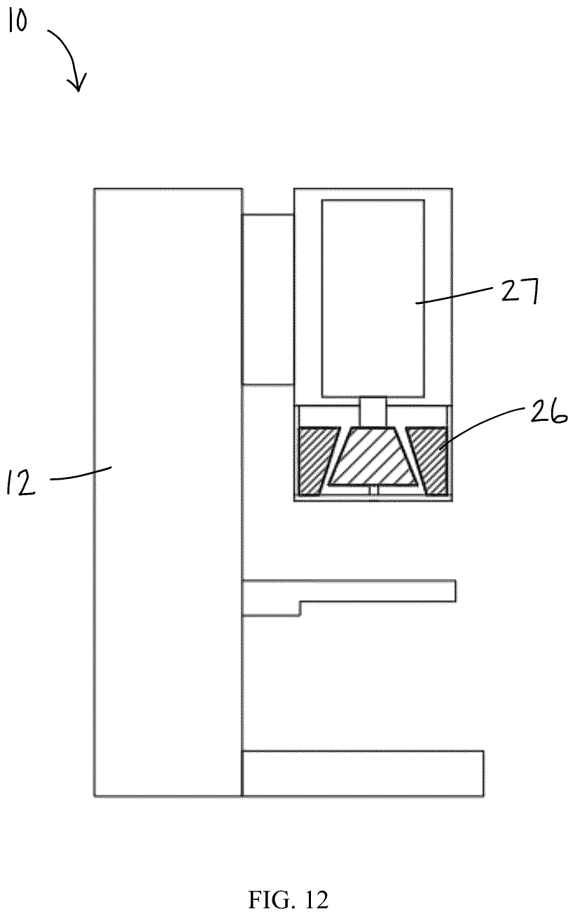

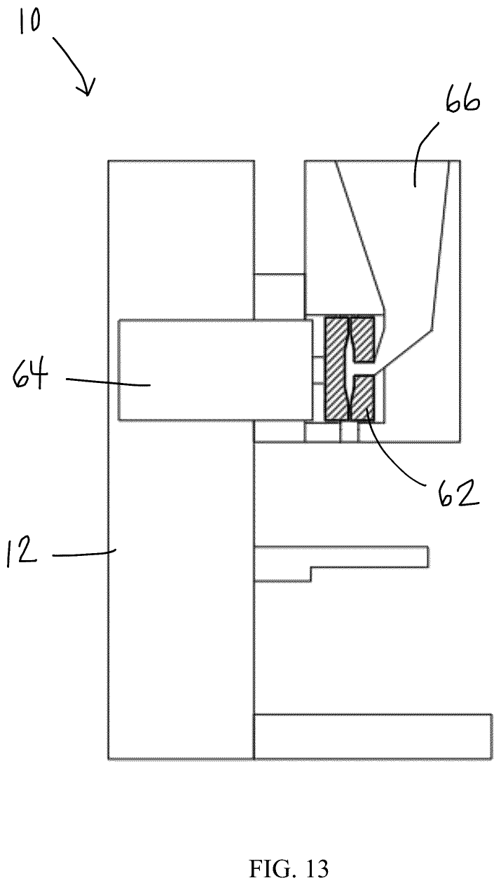

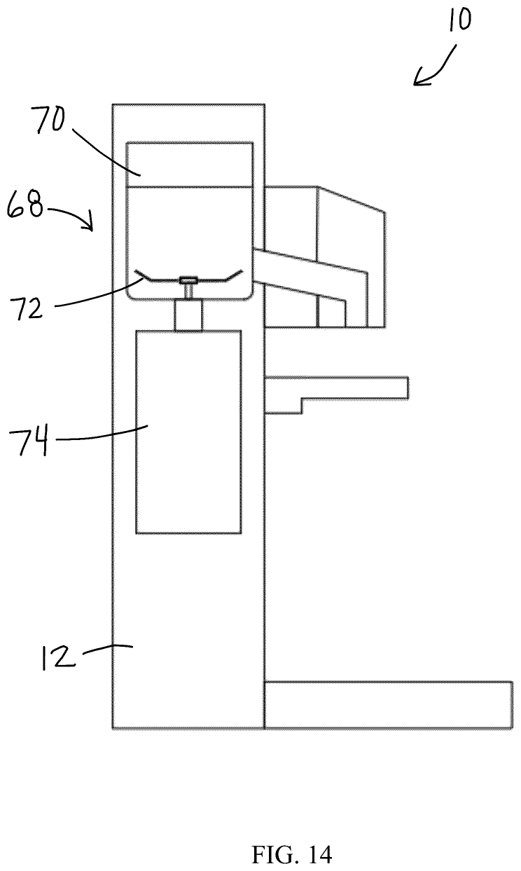

While FIGS. 10 and 11 illustrate the grinding head 14 as including a conical burr grinder 26, the present invention is not intended to be so limited in this regard. Rather, the grinding head 14 may have one of a variety of different types of grinding mechanisms. In particular, with reference to FIGS. 12, 13 and 14, the grinding head of the coffee brewing apparatus may include a conical burr grinder 26, as described above in connection with FIGS. 10 and 11, and as illustrated schematically in FIG. 12. Alternatively, the grinding head 14 may include a flat burr grinder 62, which has a horizontally-oriented motor 64, and a hopper 66 that funnels ingredients to the flat burrs of the flat burr grinder 62. Moreover, the grinding head 14 may instead include a blade-style grinder 68 having a hopper 70, a blade 72 rotatably mounted within the hopper 70, and a motor 74 beneath the hopper 70 for rotatably driving the blade 72 to grind coffee beans within the hopper.

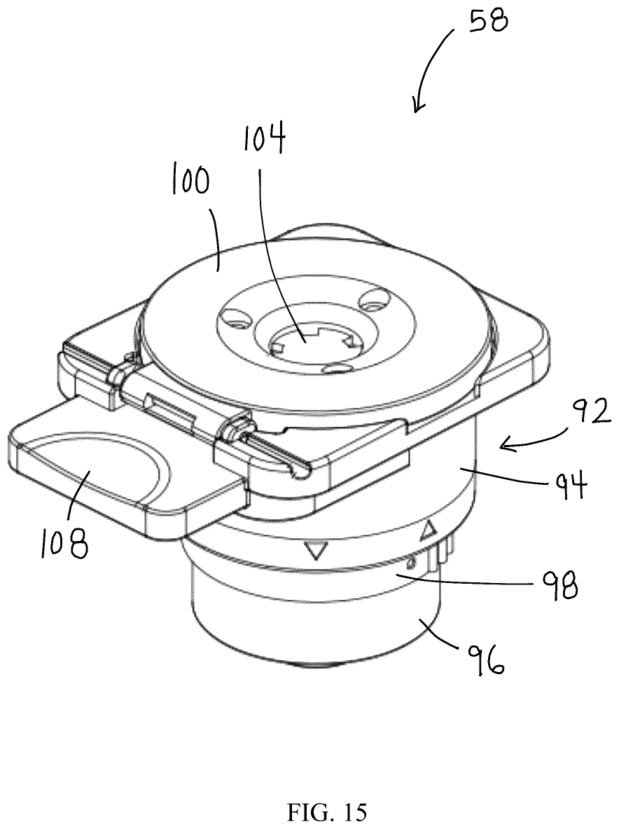

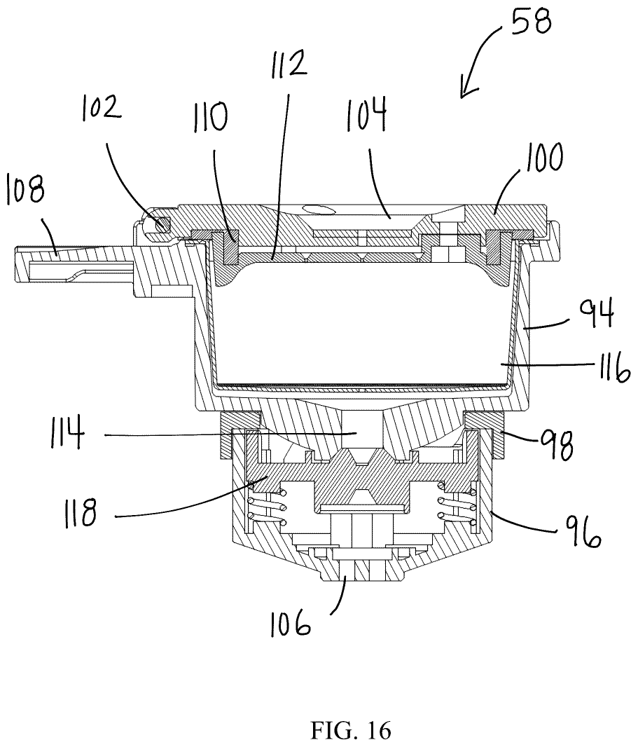

In an embodiment, the brew head 16 is configured to accommodate a variety of different single-serve pods or cartridges containing beverage ingredients such as ground coffee. For example, in one embodiment, the brew head 16 is configured to receive a reusable, single-serve, dual pressure beverage pod of the type shown and disclosed in U.S. patent application Ser. No. 18/591,085, filed on Feb. 29, 2024, the disclosure of which is hereby incorporated by reference herein in its entirety. FIGS. 15 and 16 illustrate such a reusable, single-serve, dual pressure beverage pod 58, according to one embodiment of the invention. As shown therein, the beverage pod includes a generally cup shaped body 92 sized and configured to be received in a filter cartridge holder of a beverage or coffee machine (such as coffee brewing apparatus 10). The body 92 includes a generally cylindrical upper chamber 94, a generally conical lower chamber 96, and an actuator in the form of a rotatable control ring 98 intermediate, and interconnecting, the upper chamber 94 and the lower chamber 96. The reusable coffee and beverage pod 58 includes a lid 100 pivotally connected to the upper chamber 94 about hinge 102. The lid 100 encloses the open end of the upper chamber 94 and includes an inlet opening or aperture 104 coaxial with the upper and lower chambers 94, 96 for the ingress of heated water. The lower chamber 96 includes an outlet opening or aperture 106 at the lower end thereof and coaxial with the upper and lower chambers 94, 96. A tab 108 extends from one side of the body 92 adjacent to the hinge 102 and is graspable by a user to manipulate the pod 58, such during removal and insertion of the pod 58 with respect to the beverage or coffee machine 19.

As illustrated in FIG. 16, the internal configuration of the coffee and beverage pod 58 is shown. In an embodiment, the coffee and beverage pod 58 includes a sealing element 110 such as an O-ring or the like that forms a substantially water-tight seal between the lid 100 and the upper rim of the upper chamber 94 of the body 92 when the lid 100 is in the closed position. The coffee and beverage pod 58 also includes a shower head 112 that is configured distribute water evenly, via an array of outlets, through coffee grounds or other beverage ingredient placed within the upper chamber 94, as disclosed below. In an embodiment, the sealing element 110 and shower head 112 are integrated with the lid 100. As also shown therein, the upper chamber 94 includes a generally conical bottom having an outlet 114 in fluid communication with the lower chamber 96, which similarly has a generally conical bottom having outlet 106. In an embodiment, a lower portion of the outlet 106 has the shape of an inverted cone (having a diameter at a lower end that is greater than a diameter at a location above the lower end). A generally cylindrical filter element 116 is located within the upper chamber 94 and is configured to retain a beverage ingredient such as coffee grounds, tea leaves or the like, but allows for the passage of liquid therethrough. In an embodiment, the filter element 94 may take a variety of forms such as, for example, a fine mesh screen, a porous fabric, or the like. As disclosed more fully in U.S. patent application Ser. No. 18/591,085, the beverage pod 58 also includes an adjustable pressure valve 118 that is moveable between open and closed position (closed position shown in FIG. 16) by actuation of the control ring 98. In particular, in the closed position, the valve 118 allows high pressure (5-12 bar) to build up in the upper chamber 94 before pushing the valve 118 downward to release brewed coffee, while in the open position, the valve does not obstruct outlet 114 and thus coffee is permitted to flow freely from upper chamber 94 to lower chamber 96.

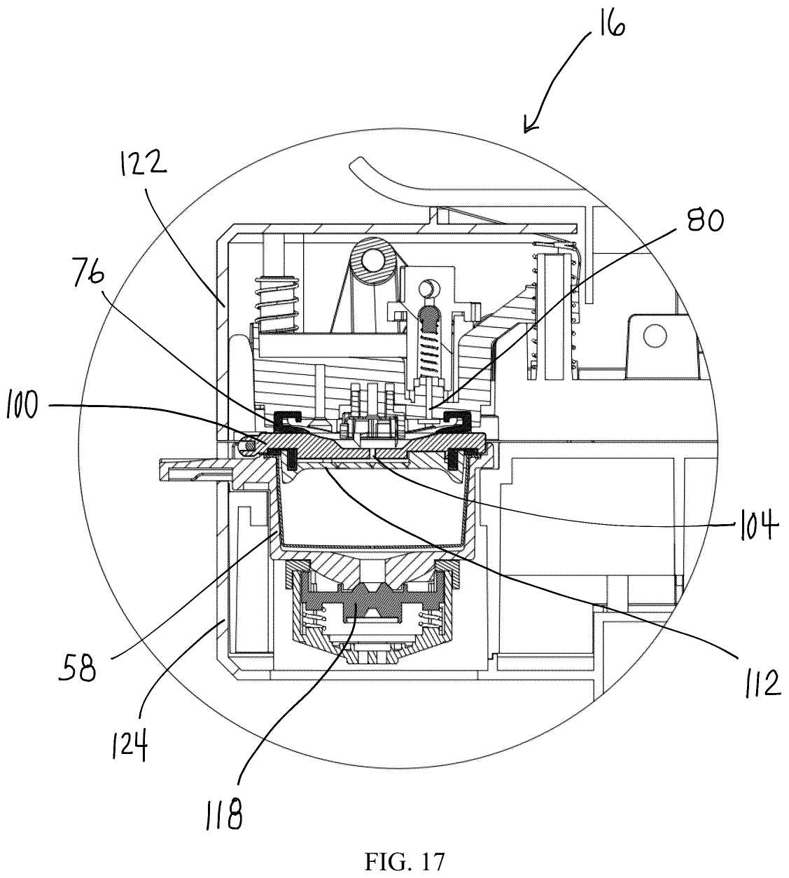

FIG. 17 shows the reusable, dual pressure beverage pod 58 received in the brewing chamber 52 of the brew head 16 of the coffee brewing apparatus 10. As shown therein, after inserting the beverage pod 58, the brew head 16 is closed, and the beverage pod 58 is locked tightly inside the brewing chamber 52 of the brew head 16. In this position, an annular sealing element 76 in the brew head 16 is compressed and sealed tightly against the lid 100 of the beverage pod 58. In this position, a water outlet 80 in the brew head 16 is in fluid communication with a shower head inlet 104 in the lid 100 of the beverage pod 58 for supplying water thereto (which provides for the flow of water to the shower head 112 of the beverage pod 58). Importantly, the sealing element 76 ensures that heated water from the water outlet 80 of the brew head 16 passes through the upper chamber 94 of the beverage pod 58 during brewing.

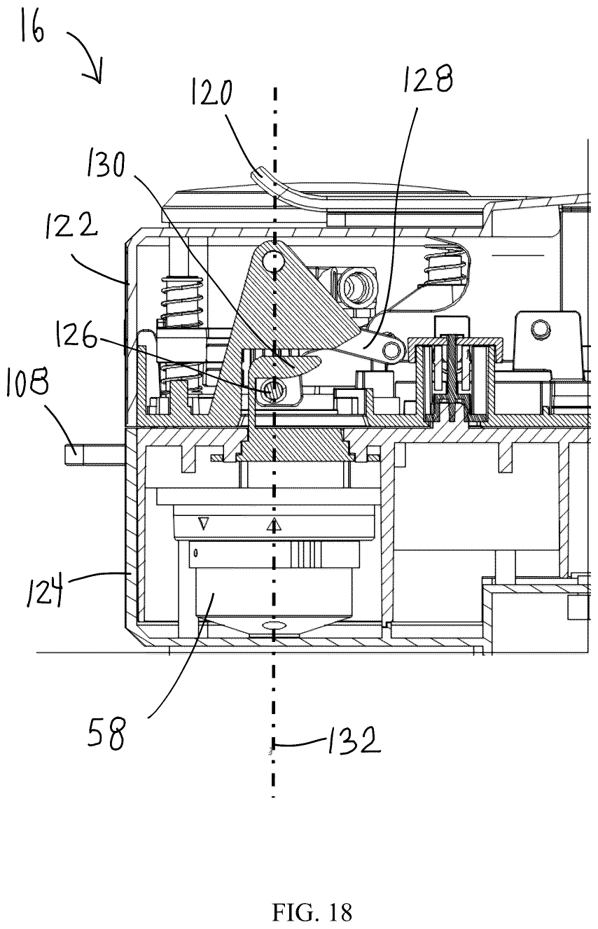

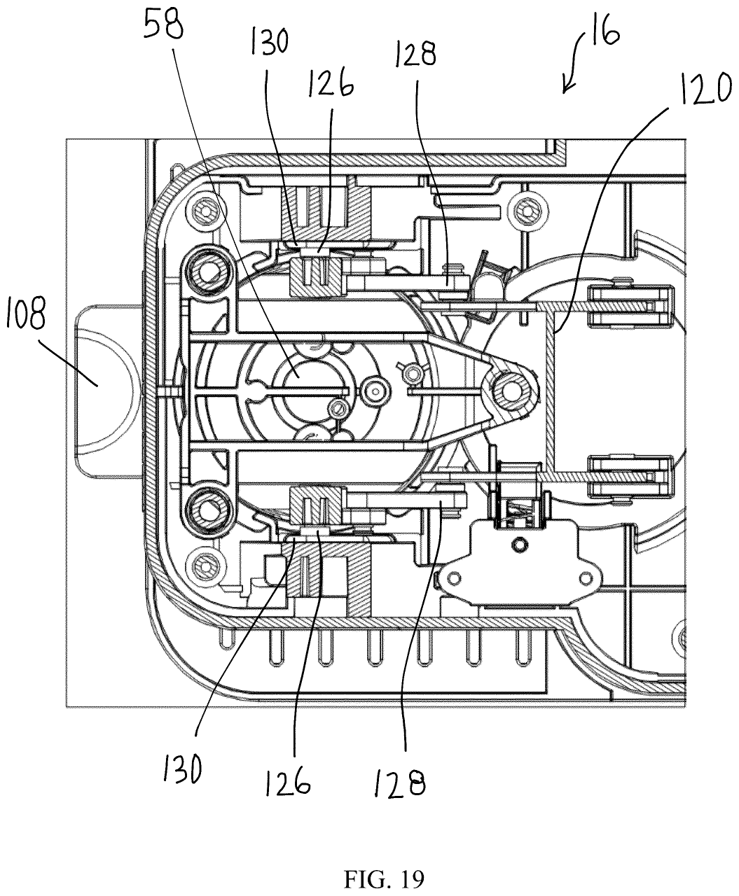

With reference to FIGS. 18 and 19, the brew head 16 includes a locking mechanism that is designed to withstand high pressures generated in the beverage pod 58 during the brewing operations (e.g., espresso brewing), but which also allows for easy beverage pod/cartridge exchange. As shown therein, the locking mechanism includes a locking lever 120 accessible from atop the brew head 16, which is operatively connected inside the upper portion 122 of the brew head 16 to a cam and follower structure. In particular, the lever 120 may be generally U-shaped and is operatively connected at respective ends thereof to a pair of followers 126 via respective cam members 128. The locking mechanism further includes opposed hooks or retaining members 130 mounted to the lower portion 124 of the brew head 16. In operation, after inserting a beverage cartridge/pod (e.g., reusable pod 58) in the brewing chamber 52 of the lower portion 124 of the brew head 16, the locking lever 120 is pushed downwardly, causing the followers 126 to move downwardly and slide beneath the respective retaining members 130, as best shown in FIG. 18. In this position, the retaining members 130 cinch or retain the followers 126 to maintain the upper portion 122 of the brew chamber 16 in contact with the lower portion 124 (and maintain the sealing element 110 in sealing contact with the lid of the beverage pod 58. As shown in FIG. 18, the retaining members 130 and followers 126 align on an axis 132 passing through the center of brewing chamber 52, which provides the greatest counter force against the brewing pressure (i.e., the pressure that builds up within the beverage pod 58). After a brewing operation, the lever 120 can be moved upwardly, which moves the followers 126 out if engagement with the retaining members 130, enabling the upper portion 122 of the brew head 16 to pivot to an open position, allowing for the beverage pod 58 to be removed from the brewing chamber 40.

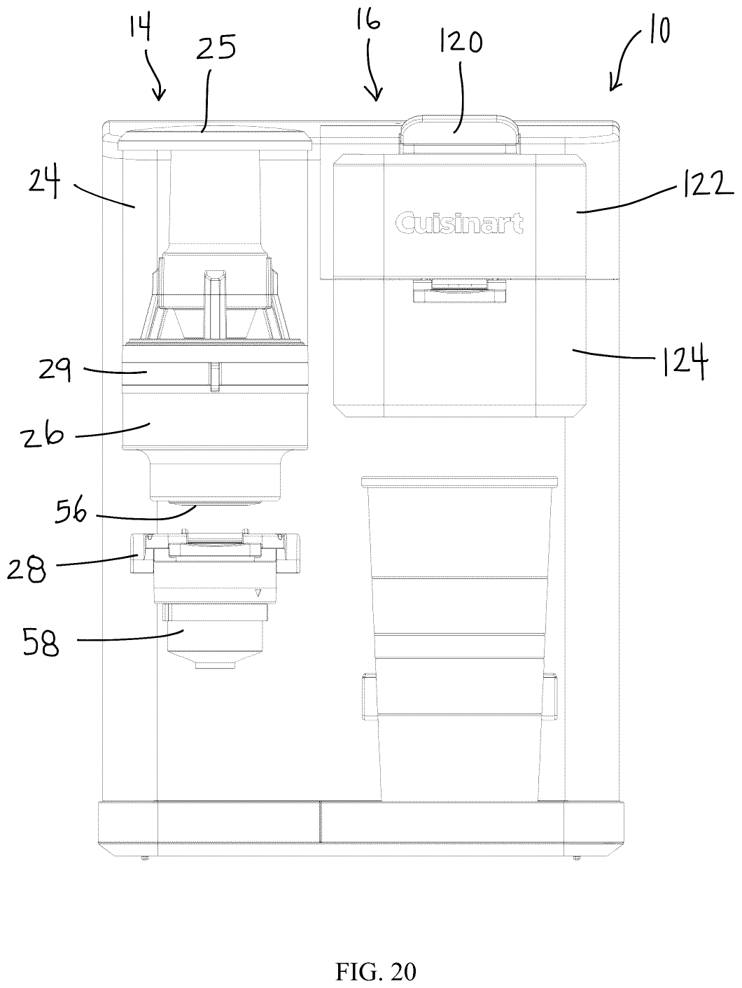

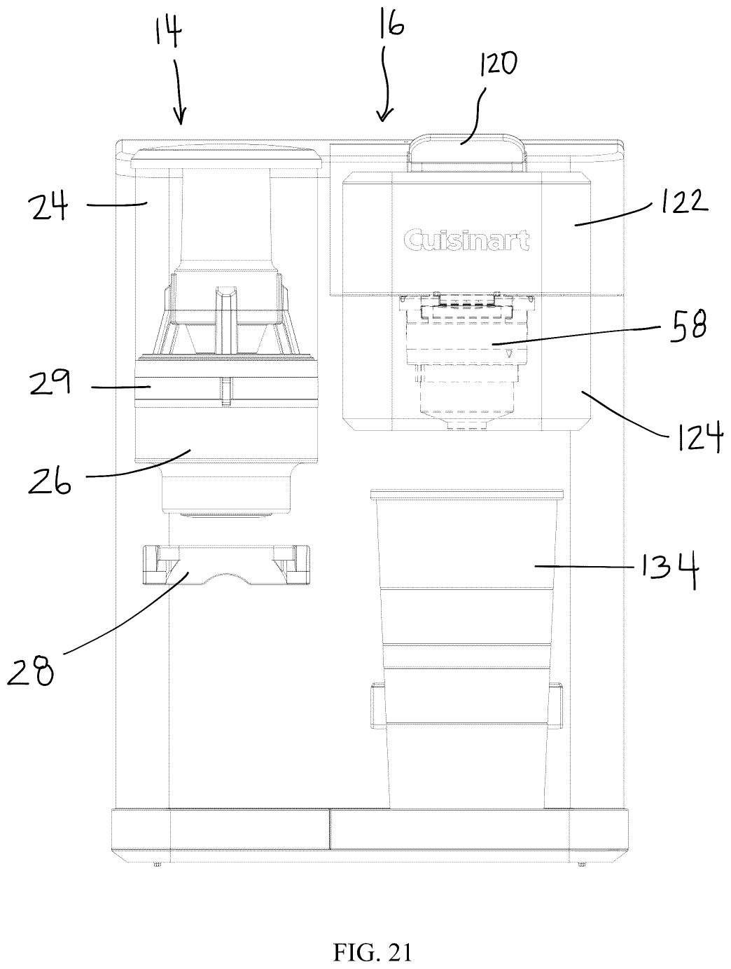

With reference to FIGS. 20 and 21, the coffee brewing apparatus 10 of the present invention combines two independently grinding and brewing systems to provide an integrated appliance. As shown in FIG. 20, a reusable beverage pod, such as beverage pod 58, can first be placed on cartridge holder 28 beneath the grinding head 14. Whole coffee beans are loaded into hopper 24, and processed into coffee grinds using burr grinder 26. The coffee grounds exit through outlet 56 and are collected in the upper chamber 94 of the beverage pod 58. After receiving an adequate amount of coffee grounds, the grinder stops automatically. The beverage pod 58 containing coffee grounds is then moved to the brew head 16 and placed in the brewing chamber in the lower portion 124 of the brew head 16, as shown in FIG. 21. A brewing operation can then be carried out to produce a brewed beverage (e.g., drip-style coffee or espresso), which is then collected in a cup or mug 134 placed beneath the brew head 16. Importantly, the grinding and brewing systems run independently, but are integrated into a single machine.

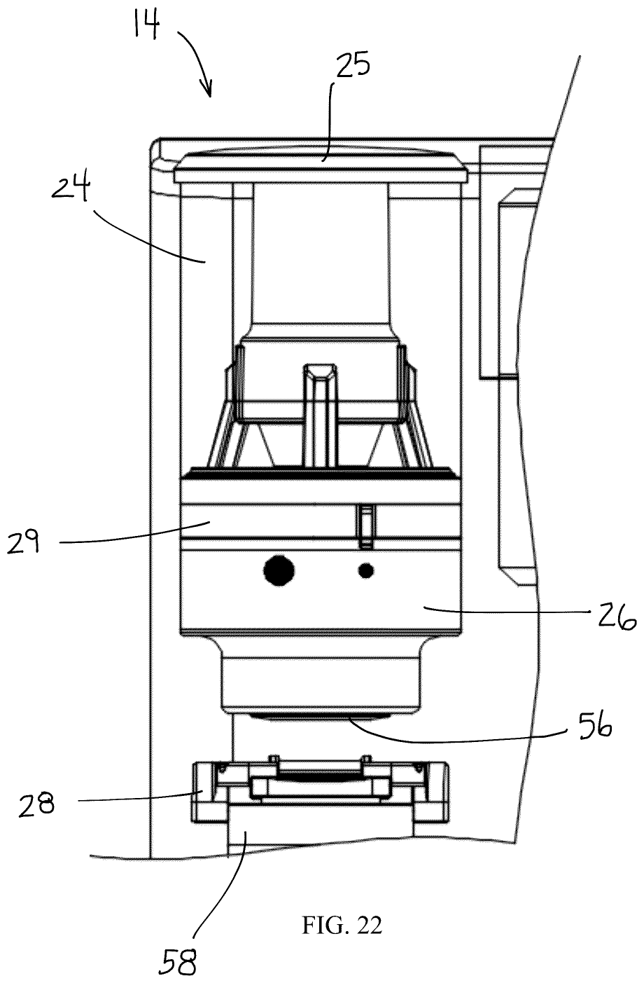

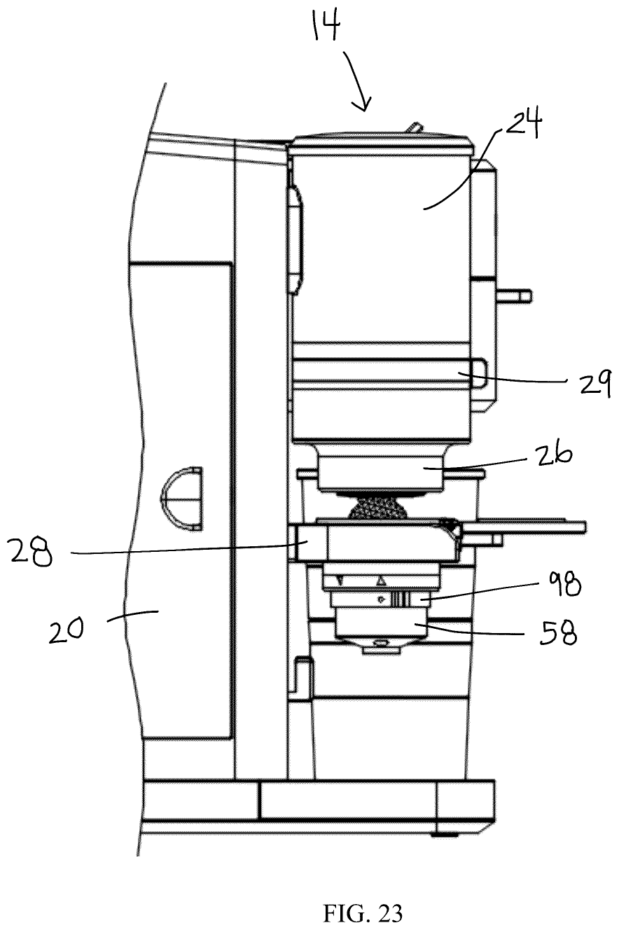

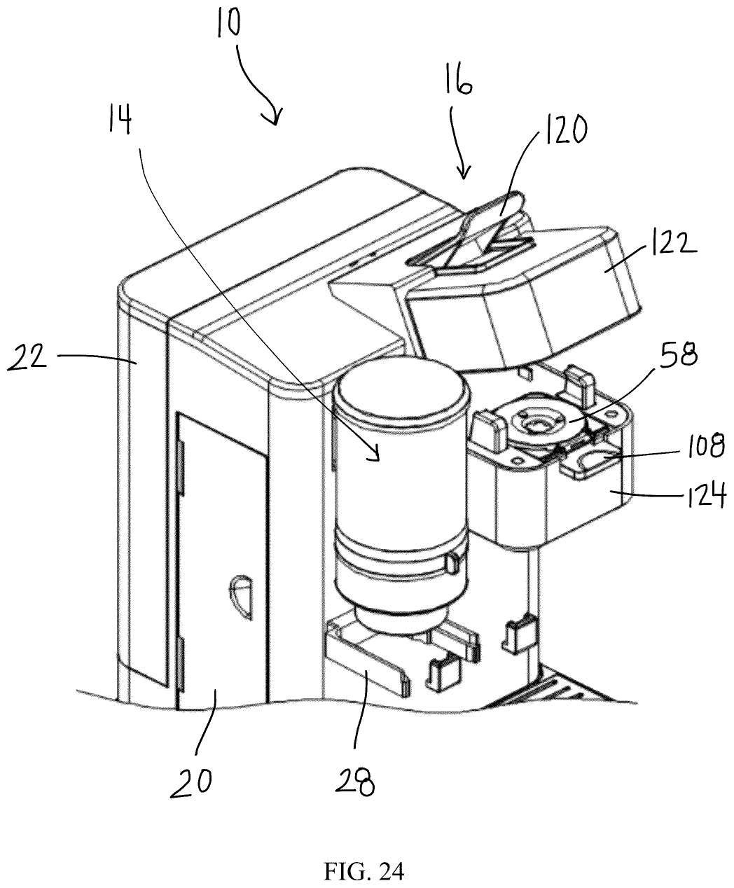

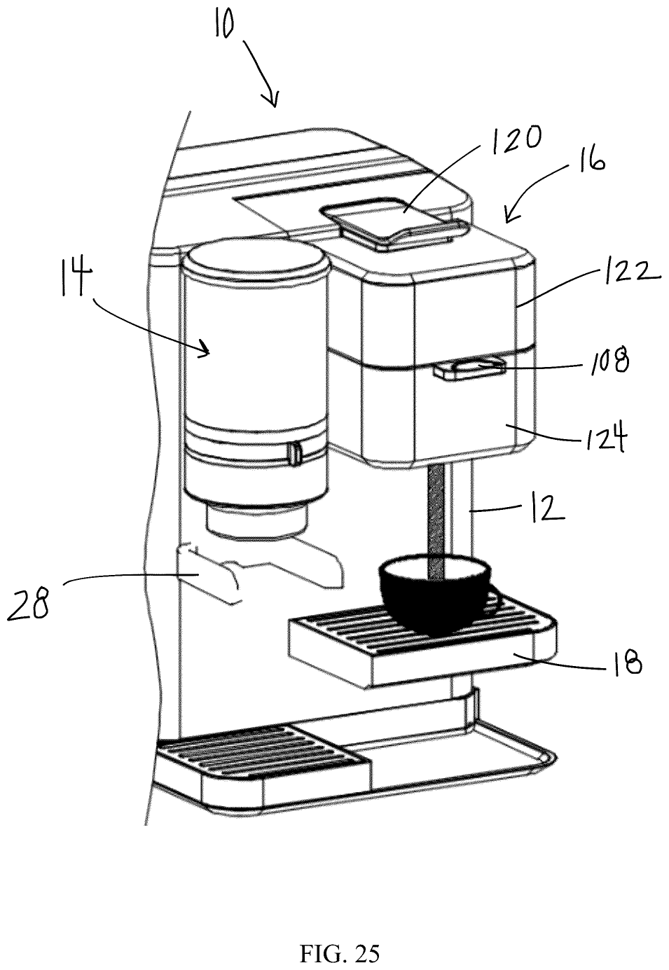

Turning now to FIGS. 22-25, the grinding system 14 may have a plurality of grinding settings corresponding to different grind sizes including, for example, a first grind setting corresponding to a coarser grind size for drip-style coffee, and a second grind setting corresponding to a finer grind size for espresso. As illustrated in FIG. 22, for example, adjustment ring 29 can be rotated to the espresso setting to produce a finer grind size suitable for espresso. At the same time, the control ring 98 of the reusable beverage pod 58 can be rotated to the high-pressure (e.g., espresso) brewing mode, causing the adjustable valve 118 to move to the closed position. As discussed above, the grinding system 14 is then actuated to controllably dispense an appropriate amount of fine coffee grounds into the beverage pod 58, as shown in FIG. 23. The beverage pod 58 is then moved to the brew head 16, as discussed above, and as shown in FIG. 24. The brewing head 16 is then closed, and an espresso brewing mode is then actuated (e.g., by a user depressing a button) to initiate brewing. The coffee brewing apparatus 10 then brews a cup of espresso according to a program stored in memory, as shown in FIG. 25. During such mode, the high-pressure pump 34 may be run at full speed, which produces a high brewing pressure (approximately 5-12 bar) within the beverage pod 58 for a short time for producing espresso. As illustrated in FIG. 25, in an embodiment, at least a portion of the drip tray 18 may be slidably mounted on the housing 12 so that a location of the drip tray 18 relative to the outlet of the brew head 16 can be adjusted, so as to prevent splattering when using smaller cups.

Alternatively, for producing a drip-style cup of coffee, the reusable beverage pod 58 is placed beneath the grinding head 14 and the adjustment ring 29 on the grinding head 14 is be rotated to the drip setting to produce a coarser grind size suitable for drip style coffee. At the same time, the control ring 98 of the reusable beverage pod 58 can be rotated to the low-pressure (e.g., drip coffee) brewing mode, causing the adjustable valve 118 to move to the open position. As discussed above, the grinding system 14 is then actuated to controllably dispense an appropriate amount of coarse coffee grounds into the beverage pod 58. The beverage pod 58 is then moved to the brew head 16, as discussed above. The brewing head 16 is then closed, and a drip coffee brewing mode is then actuated (e.g., by a user depressing a button) to initiate brewing. The coffee brewing apparatus 10 then brews a cup of drip style coffee according to a program stored in memory. During such mode, the high-pressure pump 34 may be run at a reduced speed, which produces a lower brewing pressure (less than approximately 2 bar) within the beverage pod 58 for a longer time for producing drip-style coffee.

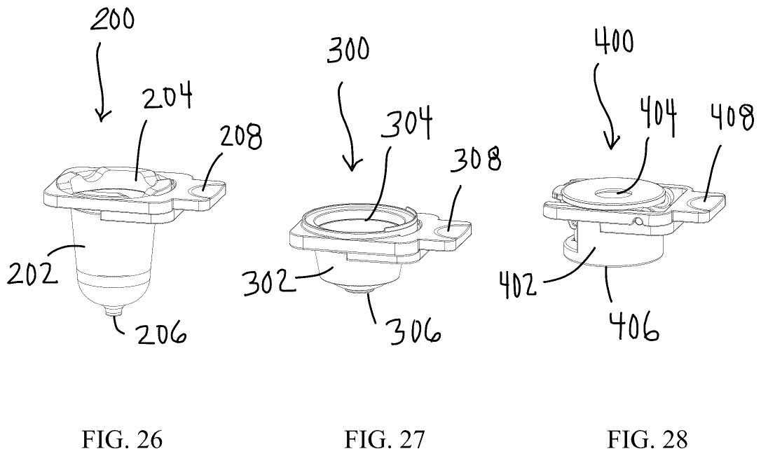

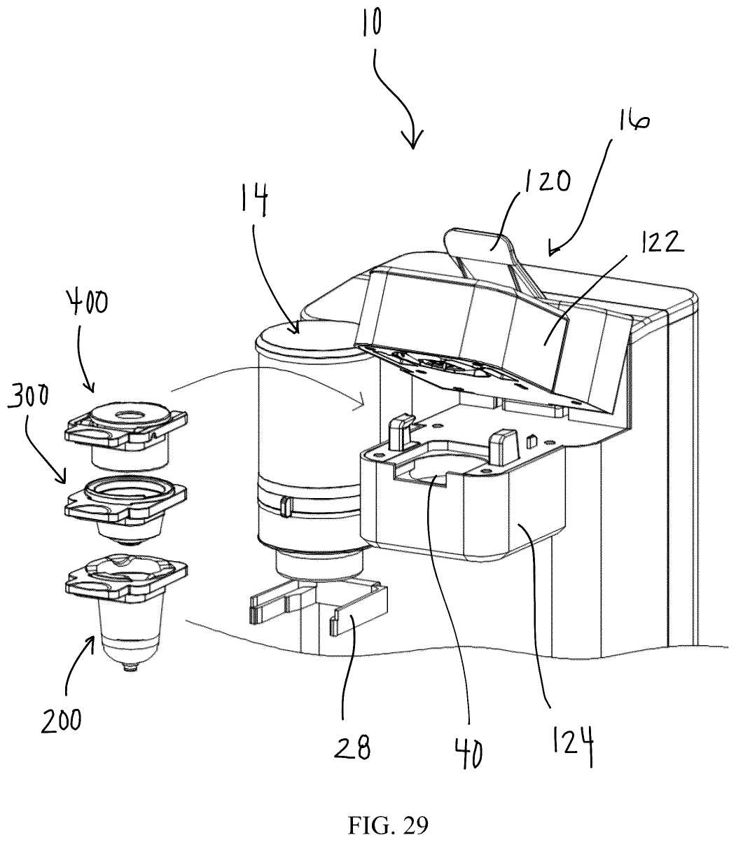

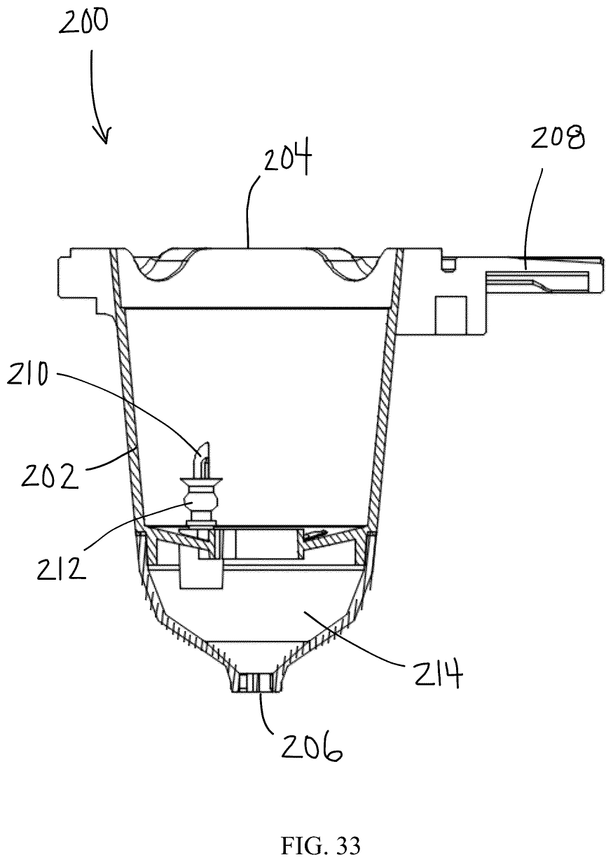

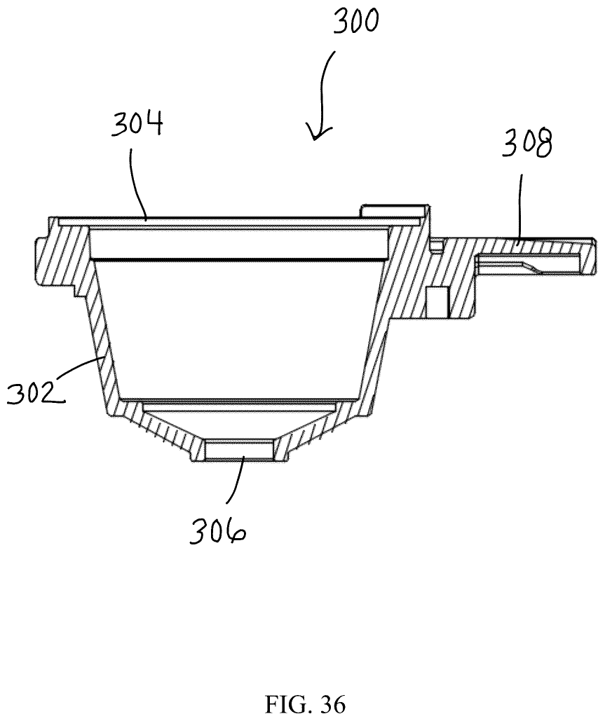

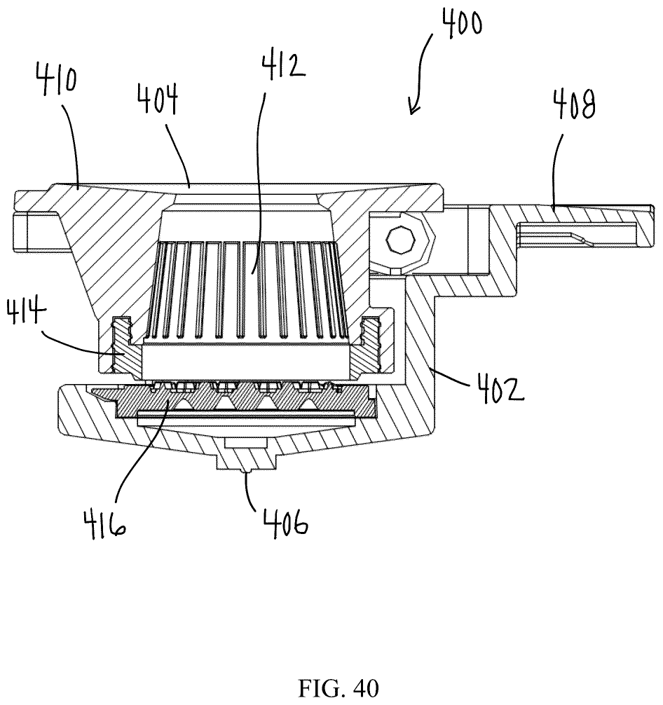

Turning now to FIGS. 26-41, the coffee brewing apparatus 10 is also configured to receive a variety of different single-serve coffee pods from different manufacturers, in addition to reusable pod 58. For example, as shown in FIGS. 26, 27 and 28, the coffee brewing apparatus 10 includes at least three interchangeable capsule holders 200, 300, 400 that are configured to receive K-cups, Dolce Gusto pods, and Nespresso capsules, respectively. As shown therein, the capsule holders 200, 300, 400 include a cup shaped body 202, 302, 402, a generally open top 204, 304, 404, an outlet 206, 306, 406 at a bottom thereof, and a grasping tab 208, 308, 408. In each case, the cup shaped body 202, 302, 402 is sized and dimensioned to receive a K-cup, Dolce Gusto pod, or Nespresso capsule, respectively. Moreover, the capsule holders 200, 300, 400 are sized and dimensioned to be received in the brewing chamber 40 in the brew head 16 in a manner similar to reusable beverage pod 58, as shown in FIG. 29.

In use, changing the capsule holders involves, opening the brew head 16 by pulling on the locking lever 120 to unlock the system and open the brew head cover, exchange the holder by placing one of the capsule holders 200, 300, 400 or the dual pressure brewing pod 58 into the brewing chamber 40, and closing and locking the brew head 16 for brewing. This simple drop-in design provides easy switching between different capsule designs and allows for various pressure brewing.

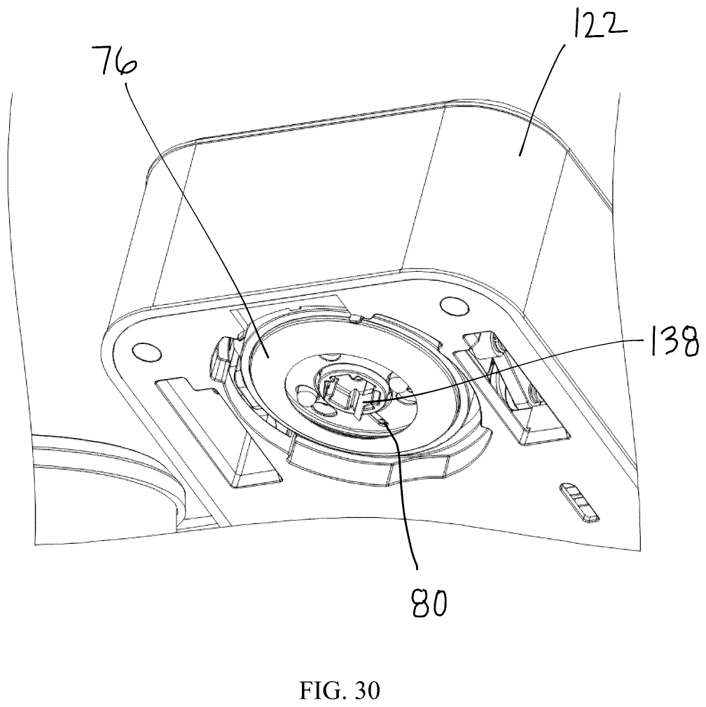

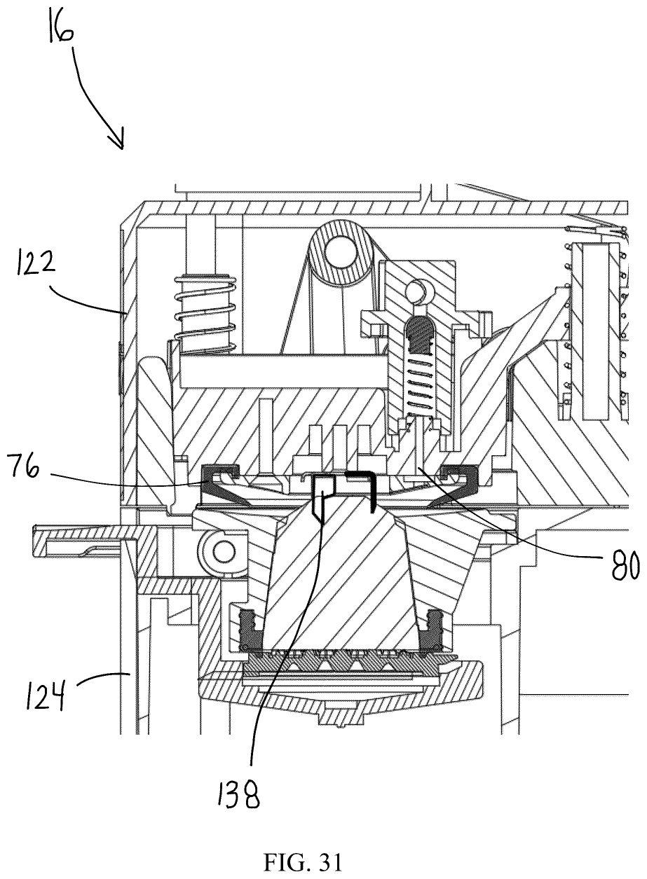

With reference to FIGS. 30 and 31, the underside of the upper portion 122 of the brew head 16 is shown, and includes a piercing mechanism 138 (which may be, for example, a 3-blade array) which are configured to cut open the capsule received in the capsule holder when the upper portion 122 of the brew head 16 is moved to the closed position and the locking lever 120 moved to the locked position. In an embodiment, all three types of capsules share a common piercing method. Importantly, as the upper portion 122 of the brew head 16 is moved to the locked position, the sealing element 76 contacts the capsule or capsule holder 200, 300, 400 to create a fluid tight seal, preventing the leak of how water from the rim of capsule holder, and ensure the hot water is pushed into the capsule for brewing. As also shown therein, the underside of the upper portion 122 of the brew head 16 also includes the water outlet 80, which provides hot water to the capsule after piercing.

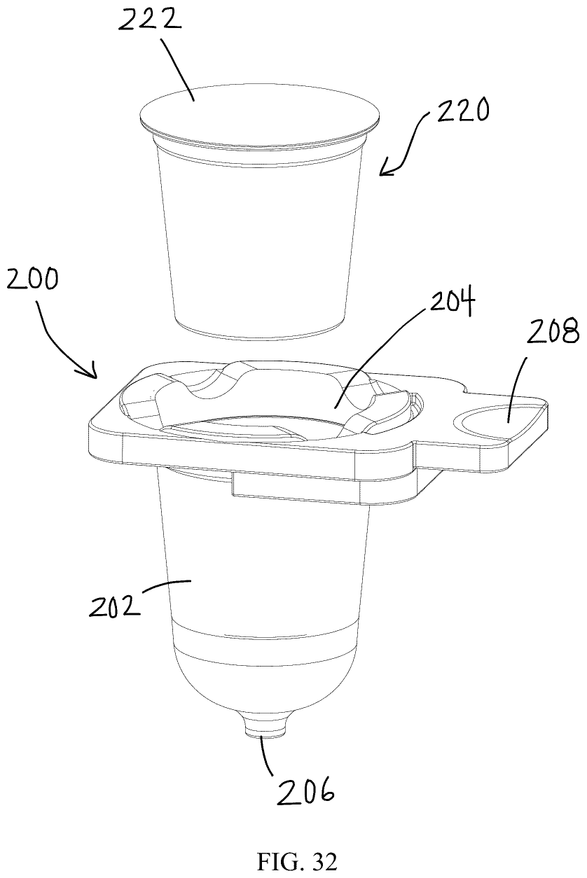

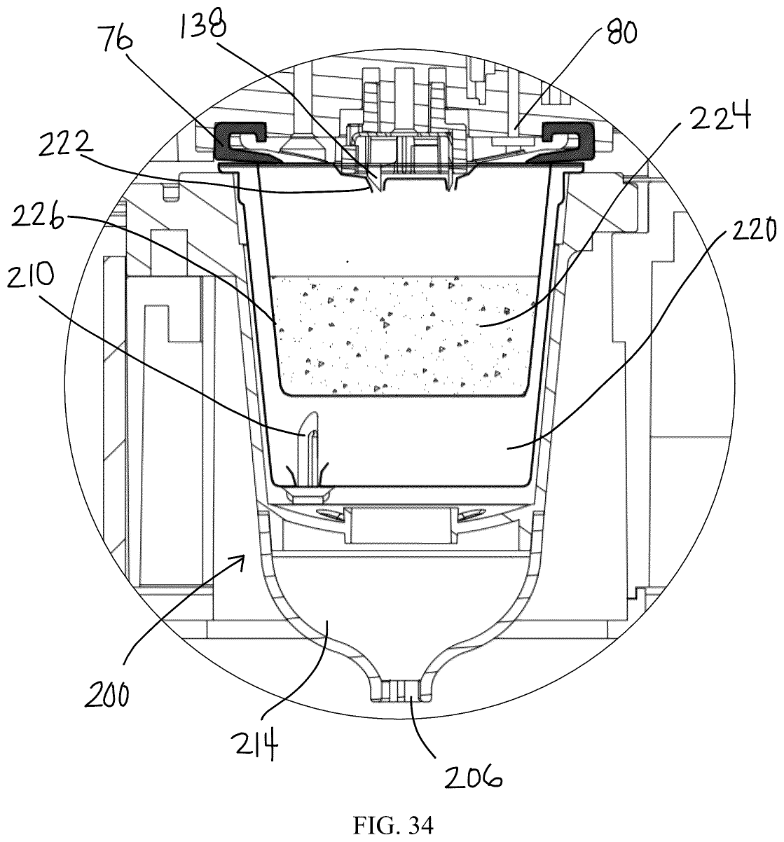

FIGS. 32-34 more clearly illustrate the configuration of the K-cup capsule holder 200 and the manner in which it receives a K-cup capsule 220 and interfaces with the coffee brewing apparatus 10. As best shown in FIG. 32 the interior of the capsule holder 200 includes a hollow needle 210 for piercing the bottom of the K-cup capsule 220 when it is received therein. The needle 210 includes an annular sealing element 212 that is configured to create a seal between the needle 210 and the bottom of the K-cup capsule 220 when the needle 210 penetrates the capsule 220. Beneath the needle 210 is a lower chamber 214 in fluid communication with the interior passage of the needle 210 for the collection of coffee. As shown in FIG. 34, after inserting a K-cup capsule 220 within the capsule holder 200, the capsule holder 200 is inserted into the brewing chamber 40 within the lower portion 124 of the brew head 16 and the brew head 16 is moved to the locked position. The piercing blade 138 penetrates the capsule foil 222 to create holes for water to flow in for brewing, and the needle 210 at the bottom of the capsule holder 200 penetrates the bottom part of the capsule to create the outlet for the beverage to flow out. Importantly, the sealing element 76 is sealed with the capsule foil 222. During brewing, the water from the water outlet 80 is forced to pass through the hole created by the piercing blade 138 in the foil 222, where it passes through coffee grounds 224 within a filter basket 226 within the capsule 220, creating brewed coffee which exits through needle 210, collects in bottom chamber 214, and exits through outlet 206.

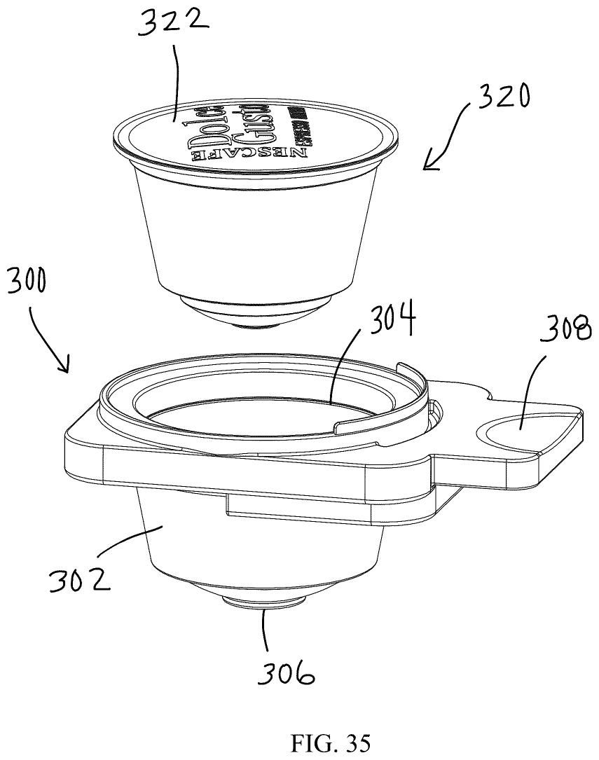

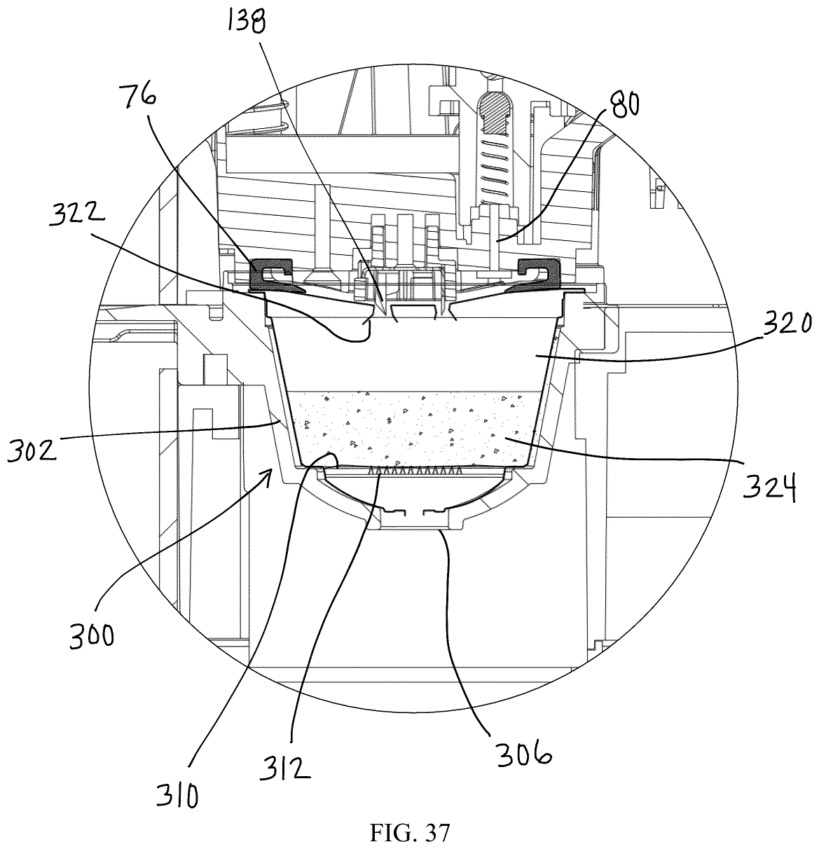

FIGS. 35-37 more clearly illustrate the configuration of the Dolce Gusto capsule holder 300 and the manner in which it receives a Dolce Gusto capsule 320 and interfaces with the coffee brewing apparatus 10. As shown in FIG. 37, after inserting a Dolce Gusto capsule 320 within the capsule holder 300, the capsule holder 300 is inserted into the brewing chamber 40 within the lower portion 124 of the brew head 16 and the brew head 16 is moved to the locked position. The piercing blade 138 penetrates the capsule foil 322 to create holes for water to flow in for brewing. Importantly, the sealing element 76 is sealed with the capsule foil 322. During brewing, the water from the water outlet 80 is forced to pass through the hole created by the piercing blade 138 in the foil 322, where it passes through coffee grounds 324 within the capsule 320. During this process, the pressure generated inside the capsule 320 presses down a foil layer 310 within the capsule 300, causing it to contact a punching bed 312 within the capsule 300, creating an outlet in the bottom of the capsule 300 through which the brewed coffee can exit the capsule 300. The brewed coffee then exits through outlet 306 in the capsule holder 300.

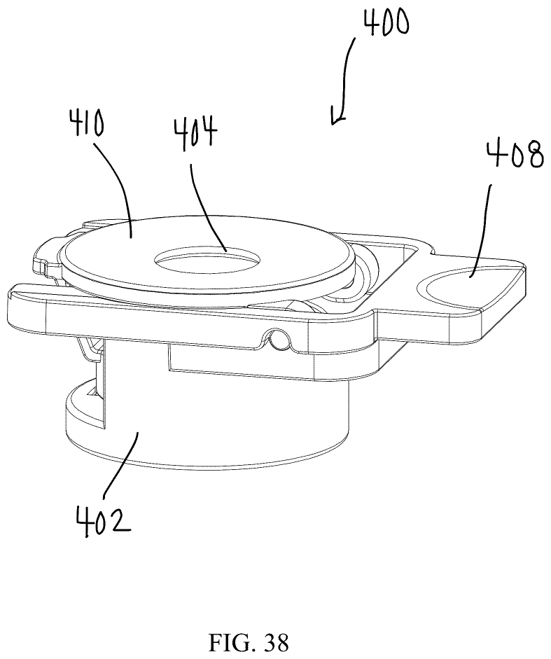

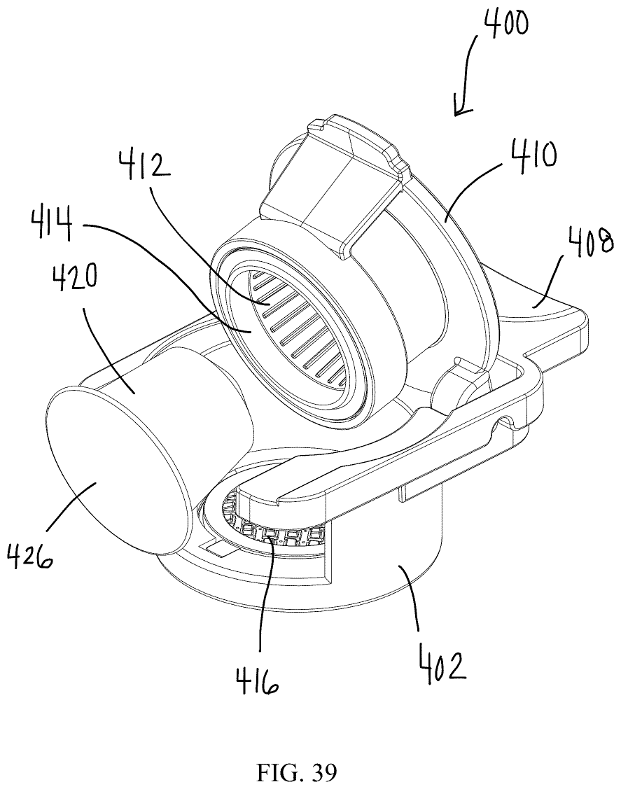

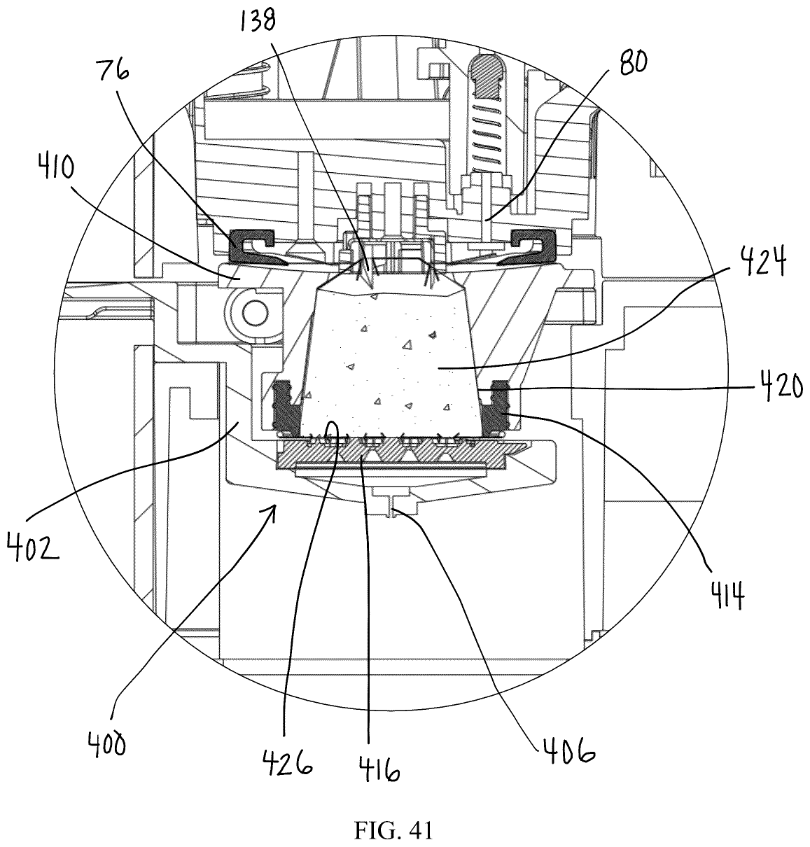

FIGS. 38-41 more clearly illustrate the configuration of the Nespresso capsule holder 400 and the manner in which it receives a Nespresso capsule 420 and interfaces with the coffee brewing apparatus 10. As best shown in FIGS. 38 and 39, the capsule holder 400 includes a cover 410 pivotally connected to the body 402, and which includes a chamber 412 having an annular sealing element 414. The floor of the body 402 includes a piercing bed 416 having a plurality of piercing elements, and allows for the flow of fluid therethrough. The cover 410 is moveable between open and closed positions. As shown in FIG. 39, in the open position, a Nespresso capsule 420 can be received in the chamber 412. As shown in FIG. 41, after inserting a Nespresso capsule 420 within the capsule holder 400, the capsule holder 400 is inserted into the brewing chamber 40 within the lower portion 124 of the brew head 16 and the brew head 16 is moved to the locked position. The piercing blade 138 penetrates the bottom of the capsule 420 (which is in the inverted position) to create holes for water to flow in for brewing. Importantly, the sealing element 76 is sealed with the capsule 420. During brewing, the water from the water outlet 80 is forced to pass through the hole created by the piercing blade 138 in the capsule 420, where it passes through coffee grounds 424 within the capsule 420. During this process, the pressure generated inside the capsule 420 presses down the foil cover 426 of the capsule, causing it to contact the piercing/punching bed 416 of the capsule holder 400, creating an outlet in the bottom of the capsule 400 through which the brewed coffee can exit the capsule 400. The brewed coffee then exits through outlet 406 in the capsule holder 400.

The coffee brewing apparatus 10 of the present invention therefore provides an easy to use system that allows for brewing of coffee beverages from whole coffee beans, or from a variety of different single-serve capsules/cartridges. The use of the reusable beverage pod also allows for the brewing of different style beverages (e.g., drip style coffee or espresso), depending on user preference. In connection with the above, the coffee brewing apparatus 10 includes a user interface, which may include a display and a variety of knobs, buttons or the like that enable a user to provide power to the appliance, select grinding and brewing functions, initiate grinding, initiate brewing, and turn off the appliance. The coffee brewing apparatus 10 additionally includes a controller configured to carry out a variety of preprogrammed grinding and brewing modes in dependence upon user selection, and is configured to control operation of, at least, the air and water pumps, heater, and grinder. Importantly, the side-by-side configuration of the grinding head 14 and brew head 16 allows a user to carry out grinding and brewing operations simultaneously, using a single reusable beverage pod 58. However, the coffee brewing apparatus 10 also allows for grinding and brewing operations to be carried out separately and independently. Accordingly, the coffee brewing apparatus 10 of the present invention provides for an ease of use and level of functionality and interchangeability heretofore not seen in the art.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A coffee brewing apparatus, comprising:
a housing;
a grinding system associated with the housing, the grinding system having a grinding mechanism for grinding coffee beans to transform the coffee beans into coffee grounds; and
a brewing system associated with the housing, the brewing system including a brewing chamber for receiving a cartridge, and a flow pathway for delivering heated water to the cartridge.

2. The coffee brewing apparatus of claim 1, wherein:
the grinding system and the brewing system are located on a front side of the housing and are positioned adjacent to one another.

3. The coffee brewing apparatus of claim 2, wherein:
the grinding system includes an outlet for discharging the coffee grounds; and
wherein the coffee brewing apparatus further includes a cartridge holder beneath the outlet of the grinding system for holding the cartridge beneath the outlet, for collection of the coffee grounds discharged by the outlet in the cartridge.

4. The coffee brewing apparatus of claim 3, wherein:
the cartridge is a reusable beverage pod.

5. The coffee brewing apparatus of claim 4, wherein:
the reusable beverage pod is selectively configurable in both a high-pressure brewing mode or a low-pressure brewing mode.

6. The coffee brewing apparatus of claim 1, wherein:
the brewing system is configured to alternately receive a plurality of cartridge holders which are each configured to receive one of a plurality of single serve capsules each having a different style or configuration.

7. The coffee brewing apparatus of claim 6, wherein:
the plurality of cartridge holders is three cartridge holders; and
the plurality of single serve capsules include a K-cup capsule, a Dolce Gusto capsule, and a Nespresso capsule.

8. The coffee brewing apparatus of claim 1, wherein:
the grinding system includes a hopper for receiving the whole coffee beans, the grinding mechanism, and an adjustment mechanism for selecting a coarseness of the coffee grounds produced by the grinding mechanism.

9. The coffee brewing apparatus of claim 1, wherein:
the grinding mechanism is one of a conical burr grinder, flat burr grinder, and blade grinder.

10. The coffee brewing apparatus of claim 1, wherein:
the brewing system includes a brew head having an upper portion and a lower portion, the lower portion containing the brewing chamber, the upper portion being moveable relative to the lower portion between an open position and a closed position; and
wherein the brewing system further includes a locking mechanism for maintaining a seal between a sealing element surrounding a water outlet in the brew head and the cartridge.

11. The coffee brewing apparatus of claim 1, further comprising:
a drip tray slidably received by the housing and movable between a raised position and a lowered position.

12. The coffee brewing apparatus of claim 1, wherein:
the coffee brewing apparatus is operable in both a high-pressure brewing mode to produce an espresso style coffee beverage, and a low-pressure brewing mode to produce a drip style coffee beverage.

13. A method for producing coffee, comprising the steps of:
positioning a cartridge beneath a grinding mechanism of a coffee brewing apparatus;
actuating the grinding mechanism to transform coffee beans into coffee grounds;
collecting the coffee grounds in the cartridge;
moving the cartridge with coffee grounds from a position beneath the grinding mechanism to a brewing chamber within a brew head located adjacent to the grinding mechanism; and
initiating a brewing operation to cause heated water to pass through the coffee grounds within the cartridge.

14. The method according to claim 13, further comprising the step of:
adjusting the grinding mechanism to select a coarseness of the coffee grounds produced by the grinding mechanism.

15. The method according to claim 14, further comprising the step of:
adjusting the cartridge to one of a low-pressure brewing mode or a high-pressure brewing mode.

16. The method according to claim 13, further comprising the step of:
placing a single-serve capsule containing coffee grounds in a capsule holder;
positioning the capsule holder in the brewing chamber; and
initiating a subsequent brewing operation to cause heated water to pass through the coffee grounds within the single-serve capsule.

17. The method according to claim 16, wherein:
the single-serve capsule is one of a K-cup capsule, a Dolce Gusto capsule, and a Nespresso capsule.

18. A coffee brewing apparatus, comprising:
a housing;
a grinding system located on a front the housing, the grinding system having a grinding mechanism for grinding coffee beans to transform the coffee beans into coffee grounds;
a cartridge holder located beneath the grinding mechanism for holding the cartridge beneath the grinding mechanism, for collection of the coffee grounds discharged by the grinding mechanism in the cartridge; and
a brew head located on the front of the housing adjacent to the grinding system, the brew head including a brewing chamber for receiving the cartridge containing the coffee grounds, the brew head being movable between an open position allowing access to the brewing chamber for insertion and/or removal of the cartridge, and a closed position.

19. The coffee brewing apparatus of claim 18, wherein:
the brewing chamber of the brew head is configured to alternately receive a plurality of cartridge holders which are each configured to receive one of a plurality of single serve capsules each having a different style or configuration.

20. The coffee brewing apparatus of claim 19, wherein:
the plurality of cartridge holders is three cartridge holders; and
the plurality of single serve capsules include a K-cup capsule, a Dolce Gusto capsule, and a Nespresso capsule.
